(19) United States
(12) Patent Application Publication
(10) Pub. No.: US 2006/0011594 A1
(43) Pub. Date: Jan. 19, 2006

(54) Processing apparatus using laser beam

(75) Inventor: Hiroshi Morikazu, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/156,595

(22) Filed: Jun. 21, 2005

(30) Foreign Application Priority Data
Jun. 23, 2004 (JP) 2004-185490

(51) Int. Cl. B23K 26/08

(52) U.S. Cl. 219/121.82

(57) ABSTRACT

A processing apparatus comprising holding means for holding a workpiece, and laser beam application means for applying a laser beam to the workpiece held by the holding means. The holding means has a holding surface on which the workpiece is placed, and the holding surface is defined by a holding member formed of polytetrafluoroethylene.

### FIELD OF THE INVENTION

This invention relates to a processing apparatus comprising a holding means for holding a workpiece, and a laser beam application means for irradiating the workpiece, which is held by the holding means, with a laser beam.

### DESCRIPTION OF THE PRIOR ART

In the production of a semiconductor device, it is well known that a plurality of rectangular regions are defined on the face of a semiconductor wafer by streets arranged in a lattice pattern, and a semiconductor circuit is formed in each of the rectangular regions. Then, the semiconductor wafer is cut along the streets to separate the rectangular regions individually for use as semiconductor devices.

As disclosed in Japanese Patent No. 3408805 and Japanese Patent Application Laid-Open No. 2003-320466, the use of a processing apparatus using a laser beam is proposed for the cutting along the streets of the semiconductor wafer. Such a processing apparatus is equipped with a holding means for holding a workpiece, such as a semiconductor wafer, and a laser beam application means for irradiating the workpiece, which is held by the holding means, with a laser beam. A typical example of the holding means includes a porous holding member formed of a ceramic such as alumina. The workpiece is laid on the surface of the holding member, and air is sucked through the holding member, whereby the workpiece is vacuum attracted to the surface of the holding member. The laser beam application means includes a laser beam oscillation means, such as a YAG laser oscillator or a YVO4 laser oscillator, and irradiates the workpiece with a pulsed laser beam having a wavelength of 355 to 1064 nm.

The above-described conventional processing apparatus has been found to pose the following problems: The laser beam is directed at the holding member of the holding means, as well as the workpiece. Part of the laser beam directed toward the workpiece passes through the workpiece, and arrives at the holding member. Furthermore, when the holding member and the laser beam application means are moved relative to each other, it is not rare that the laser beam is moved relatively beyond the outer edge of the workpiece, and is directly applied to the surface of the holding member. If the holding member is formed of a ceramic such as alumina, the holding member tends to be damaged or overheated upon exposure to the laser beam. If a protective tape, which is a plastic film or sheet, is stuck to the face of the workpiece in intimate contact with the surface of the holding member (the face of the workpiece has semiconductor circuits formed thereon), the overheating of the holding member results in the melting of the protective tape. The molten protective tape is fusion bonded to the surface of the holding member. This makes it difficult to remove the workpiece from the holding member, and the surface of the holding member is injured.

### SUMMARY OF THE INVENTION

It is a principal object of the present invention, therefore, to provide a novel and improved processing apparatus in which even if the surface of the holding means for holding the workpiece is exposed to a laser beam, damage to or overheating of the holding means is sufficiently avoided or curbed.

We, the inventors, diligently conducted studies and experiments, and recognized the following facts: A holding member made of a ceramic, such as alumina, has so far been used as a holding member which defines the surface of a holding means. If a laser beam having a wavelength of, say, 355 to 1064 nm is directed at the ceramic holding member, the energy absorption coefficient of the ceramic holding member is relatively high, so that the holding member is damaged or overheated. Based on this recognition, the inventors conducted further investigations, and have found that polytetrafluoroethylene has a sufficiently low energy absorption coefficient for a laser beam having a wavelength of 355 to 1064 nm; hence, the aforementioned principal object can be attained by forming the holding member, which defines the surface of the holding means, from polytetrafluoroethylene.

That is, according to the present invention, as a processing apparatus for attaining the above principal object, there is provided a processing apparatus, which comprises holding means for holding a workpiece, and laser beam application means for applying a laser beam to the workpiece held by the holding means, and wherein
the holding means has a holding surface on which the workpiece is placed, and
the holding surface is defined by a holding member formed of polytetrafluoroethylene.

Preferably, the holding member is porous. In a preferred embodiment, the laser beam application means applies a pulsed laser beam having a wavelength of 355 to 1064 nm.

### BRIEF DESCRIPTION OF THE DRAWINGS

FIG. 1 is a schematic view showing essential parts of a preferred embodiment of a processing apparatus constructed in accordance with the present invention.

FIG. 2 is a graph showing the energy absorption coefficients of polytetrafluoroethylene and alumina.

### DETAILED DESCRIPTION OF THE PREFERRED EMBODIMENTS

Preferred embodiments of a processing apparatus constructed in accordance with the present invention will now be described in detail by reference to the accompanying drawings.

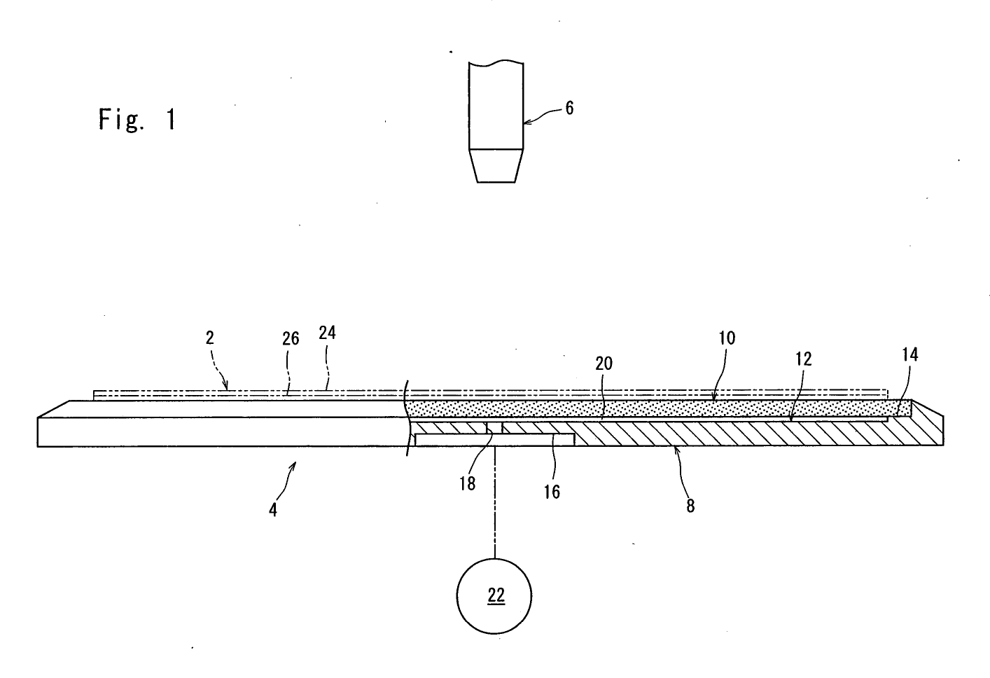

FIG. 1 shows a preferred embodiment of a processing apparatus constructed in accordance with the present invention. The illustrated processing apparatus comprises a holding means 4 for holding a workpiece 2, and a laser beam application means 6 for applying a laser beam to the workpiece 2 held on the holding means 4.

The holding means 4 in the illustrated embodiment is composed of a base 8, and a holding member 10. The base 8, which can be formed from a suitable metal such as a stainless steel, is disk-shaped as a whole, and a concave portion 12 circular in a plan view is formed on the upper surface of the base 8. An annular step 14 is formed at a peripheral edge part of the concave portion 12, and the depth of the peripheral edge part of the concave portion 12 is somewhat smaller than the depth of a central main part of the concave portion 12. A concave portion 16 circular in a plan view is formed at a central part of the lower surface of the base 8. A through-hole 18, which brings the concave portion 12 and the concave portion 16 into communication, is formed at the center of the base 8. The holding member 10, which is formed from a porous material, is disk-shaped, and its outer diameter is substantially the same as the inner diameter of the base 8. The holding member 10 in such a configuration is fixed to the concave portion 12 by having a peripheral edge part of its lower surface bound to the annular step 14 of the concave portion 12 by a suitable adhesive. The flat upper surface of the holding member 10 may be at substantially the same height as the upper end of the base 8. A clearance 20 is present between the lower surface of the holding member 10 and the bottom surface of the central main part of the concave portion 12. The concave portion 16 formed at the lower surface of the base 8 is connected to a suction means 22, which may be a vacuum pump, via a suitable communication passage (not shown).

The workpiece 2 is laid on the upper surface of the holding member 10 in the holding means 4. The illustrated workpiece 2 is composed of a disk-shaped semiconductor wafer 24, and a protective tape 26 stuck to the lower surface of the semiconductor wafer 24. A plurality of rectangular regions are defined on the face, namely, the lower surface, of the semiconductor wafer 24 by streets arranged in a lattice pattern, although this is not shown. A semiconductor circuit is disposed in each of the rectangular regions. The protective tape 26 stuck to the lower surface of the semiconductor wafer 24 may be a suitable plastic film or sheet, such as a polyester film or sheet. After the workpiece 2 is laid on the holding member 10 of the holding means 4, the suction means 22 is actuated to suck air via the clearance 20, the through-hole 18, and the concave portion 16, whereby the workpiece 2 is vacuum attracted onto the holding member 10.

The laser beam application means 6 includes a laser oscillation means (not shown) which is advantageously a YAG laser oscillator or a YVO4 laser oscillator. The laser beam application means 6 irradiates the workpiece 2 with a pulsed laser beam having a wavelength, for example, of 335 to 1064 nm.

In the illustrated embodiment, the laser beam application means 6 is mounted to be movable in an up-and-down direction in FIG. 1. By adjusting the position, in the up-and-down direction, of the laser beam application means 6, the focused position of the laser beam is set to be, for example, at a middle part, in the thickness direction, of the semiconductor wafer 24. The holding means 4 is mounted to be rotatable about a central axis extending in the up-and-down direction in FIG. 1, and is also mounted to be movable in a right-and-left direction and a direction perpendicular to the sheet face in FIG. 1. By moving the holding means 4, as appropriate, the focused position of the laser beam from the laser beam application means 6 is brought to fall within a predetermined street. By moving the holding means 4 in the right-and-left direction in FIG. 1, the laser beam from the laser beam application means 6 and the workpiece 2 are moved relative to each other along the street.

The foregoing features and actions in the illustrated processing apparatus do not constitute the novel characteristics of the processing apparatus configured in accordance with the present invention. Their details may be substantially the same as those of the processing apparatus disclosed in the aforementioned Japanese Patent Application Laid-Open No. 2003-320466. Thus, their detailed descriptions are omitted herein by citing the descriptions of Japanese Patent Application Laid-Open No. 2003-320466.

With further reference to FIG. 1, it is important in the processing apparatus of the present invention that the holding member 10, which defines the holding surface for bearing the workpiece 2 in the holding means 4, be formed from polytetrafluoroethylene. In the processing apparatus of the type which attracts the workpiece 2 under vacuum to the surface of the holding member 10, the holding member 10 advantageously has pores comprising open-cells, and its cell proportion is preferably of the order of 20 to 60%.

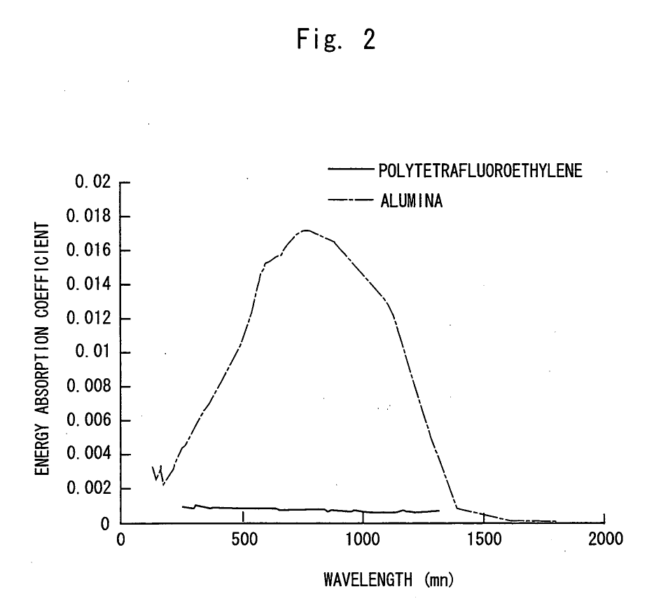

FIG. 2 shows the relationship between the wavelength of the laser beam and the energy absorption coefficient of each of polytetrafluoroethylene and alumina. The relation between the wavelength of the laser beam and the energy absorption coefficient of alumina is based on the values contained in “Handbook of Optical Constants of Solid Palik” published by Academic Press, Inc. On the other hand, the relation between the wavelength of the laser beam and the energy absorption coefficient of polytetrafluoroethylene is based on the results of experiments in which a beam from a spectroscope was directed at a solid plate member of polytetrafluoroethylene, the intensity of transmitted light was actually measured, and the energy absorption coefficient was calculated based on the measured values. As will be clearly understood by reference to FIG. 2, the energy absorption coefficient of polytetrafluoroethylene is markedly low compared with the energy absorption coefficient of alumina with respect to the laser beam having a wavelength of 355 to 1064 nm which is generally used in a processing apparatus. In the processing apparatus of the present invention having the holding member 10 formed from polytetrafluoroethylene, therefore, the damage to or overheating of the holding member 10 due to irradiation with the laser beam is sufficiently avoided or curbed.

While the preferred embodiments of the processing apparatus constructed according to the present invention have been described in detail by reference to the accompanying drawings, it is to be understood that the invention is not limited to such embodiments, but various changes and modifications may be made without departing from the scope of the invention.

What we claim is:

1. A processing apparatus comprising holding means for holding a workpiece, and laser beam application means for applying a laser beam to the workpiece held by the holding means, and wherein
the holding means has a holding surface on which the workpiece is placed, and
the holding surface is defined by a holding member formed of polytetrafluoroethylene.

2. The processing apparatus according to claim 1, wherein the holding member is porous.

3. The processing apparatus according to claim 1, wherein the laser beam application means applies a pulsed laser beam having a wavelength of 355 to 1064 nm.
